(19) United States
(12) Patent Application Publication
(10) Pub. No.: US 2006/0048649 A1
(43) Pub. Date: Mar. 9, 2006

(54) Canister air filter structure

(76) Inventor: Byung-Chul Lee, Gunpo-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/213,475

(22) Filed: Aug. 25, 2005

(30) Foreign Application Priority Data
Sep. 6, 2004 (KR) 10-2004-0070838

(51) Int. Cl. B01D 53/02

(52) U.S. Cl. 96/143

(57) ABSTRACT

A filter element in a canister air filter automatically eliminates impurities according to its contaminated degree, thereby retaining the ventilation resistance of the canister air filter below a predetermined level and preventing damage to a fuel tank and other components adjacent thereto. The canister air filter includes a housing, filter element, and amplitude limiting means.

### CROSS-REFERENCE TO RELATED APPLICATIONS

The present application is based on, and claims priority from, Korean Application Serial Number 10-2004-0070838, filed on Sep. 6, 2004, the disclosure of which is hereby incorporated by reference herein in its entirety.

### FIELD OF THE INVENTION

Generally, the present invention relates to the structure of a canister air filter. More particularly, the present invention relates to a fixing structure of a filter element.

### BACKGROUND OF THE INVENTION

Typically, a canister is used in a fuel system of a vehicle to collect fuel vapors generated from a fuel tank. When certain conditions are met in an engine, the collected vapors are purged into the engine for combustion. This prevents leakage of the fuel vapor to the atmosphere.

As fresh air flows into the engine through the canister, gasoline vapors are purged into the intake manifold of the engine. The air entered into the canister is filtered by a canister air filter. However, if a filter element in the canister air filter is excessively contaminated, ventilation resistance increases and the fuel tank connected to the canister receives exceeding negative pressure from the engine.

### SUMMARY OF THE INVENTION

Embodiments of the present invention are provided to automatically remove contamination of a filter element mounted in the canister air filter according to the contaminated degree, thereby retaining ventilation resistance of the canister air filter below a predetermined level and preventing damage to a fuel tank and other components adjacently located thereto.

According to an embodiment, a structure of a canister air filter includes a housing and a filter element that vibrates in a perpendicular direction to an intake surface in the housing. An amplitude limiting means restricts the amplitude of the filter element.

### BRIEF DESCRIPTION OF THE DRAWINGS

For a better understanding of the nature and objects of the present invention, reference should be made to the following detailed description with the accompanying drawings, in which:

FIG. 1 illustrates a canister air filter mounted in a vehicle according to an embodiment of the present invention;

FIG. 2 shows a structure of a canister air filter with a housing cut off at one end thereof according to an embodiment of the present invention;

FIG. 3 shows a mounting portion of a plate spring of a canister air filter according to an embodiment of the present invention; and

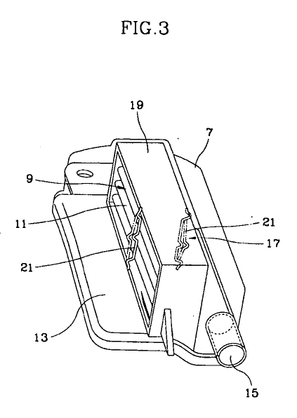

FIG. 4 illustrates a fixing structure of a plate spring of a canister air filter according to an embodiment of the present invention.

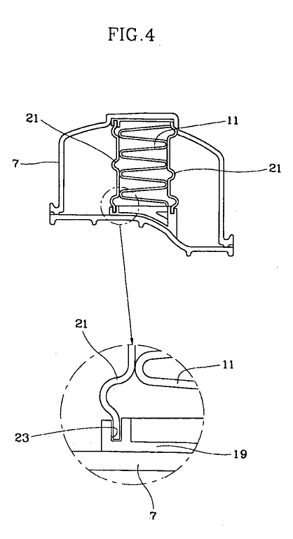

### DETAILED DESCRIPTION OF THE PREFERRED EMBODIMENTS

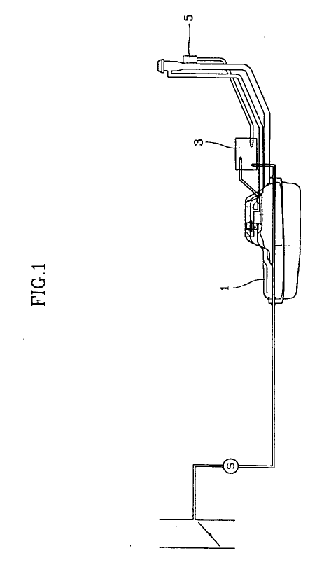

Referring to FIG. 1, a fuel tank 1 is connected with a canister 3 that is linked to a canister air filter 5. Canister 3 is configured to take in the outside air purge fuel vapors from the fuel tank into the intake systems of the engine.

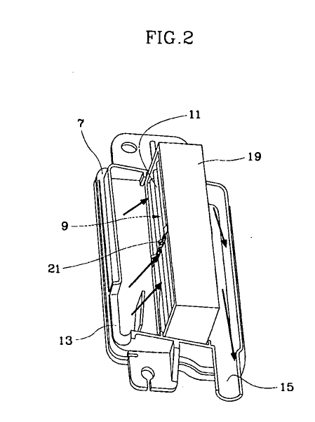

Referring now to FIG. 2, canister air filter 5 includes a housing 7 and a filter element 11 that is configured to vibrate in a perpendicular direction to an intake surface 9 in housing 7. An amplitude limiting means restricts the amplitude of filter element 11. According to an embodiment, the amplitude limiting means is a plate spring 21. According to another embodiment, the amplitude limiting means is a stopper, the stopper can be a shield, a bumper, a tab of another component of the canister apparatus, combinations thereof, and the like. Intake surface 9 designates a surface of filter element 11 into which the air enters.

Housing 7 has an inlet 13 exposed to the atmosphere and an outlet 15 in communication with canister 3. Filter element 11 is mounted between inlet 13 and outlet 15. The edges of intake surface 9 and exhaust surface 17 of filter element 11 are secured to a frame 19. The other portions of filter element 11 are not restricted in motion; hence, the center portion of filter element 11 can be vibrated corresponding to the moving direction of the air that passes through filter element 11.

Frame 19 is installed in housing 7; that is, filter element 11 is pre-secured on frame 19 as one module and then frame 19 is fastened in housing 7 to render the configuration of canister air filter 5. The amplitude limiting means in an embodiment of the present invention is composed of plate springs 21 that cross the center of intake surface 9 and exhaust surface 17 of filter element 11. Both ends of plate springs 21 are preferably fixedly inserted into insertion grooves 23 of frame 19. Thus, frame 19, filter element 11, and plate springs 21 are integrally coupled together and installed in housing 7. Both ends of plate springs 21 can also be installed at housing 7.

According to such a construction, if impurities held in the air enter into canister air filter 5, attach to filter element 11 during the purge of canister 3 and thus ventilation resistance increases, filter element 11 of canister air filter 5 vibrates automatically to remove the impurities. If the ventilation resistance of filter element 11 increases due to the attachment of impurities, filter element 11 vibrates perpendicularly to the intake surface 9 of filter element 11 in response to the variation of the internal pressure of canister 3. The amplitude is limited in a predetermined range by plate springs 21, however, the impurities on filter element 11 are removed by the above vibration amplitude. The detached impurities are released to the exterior through inlet 13 of housing 7 while the vehicle vibrates from driving motion.

The amplitude degree of filter element 11 is determined by the resilient force of plate springs 21 and a pressure difference of intake surface 9 and exhaust surface 17 of filter element 11 such that the resilient force of plate springs 21 should properly be established through experiments. Filter element 11 is prevented in advance from being excessively contaminated, whereby the ventilation resistance is maintained at an appropriate level. This prevents a deformation or damage of the fuel tank 1 or adjacent components due to the internal pressure of canister 3.

As apparent from the foregoing, there is an advantage in that the filter element in the canister air filter can automatically eliminate impurities according to the contaminated degree, thereby retaining the ventilation resistance of the canister air filter below a predetermined level and preventing any damage to a fuel tank or other components adjacent thereto.

What is claimed is:

1. A canister air filter structure, comprising:
a housing;
a filter element that is configured to vibrate in a perpendicular direction to an intake surface in said housing; and
an amplitude limiting means that restricts an amplitude of vibration of said filter element.

2. The structure as defined in claim 1, wherein said amplitude limiting means includes a plate spring that crosses a center of said intake surface of said filter element.

3. The structure as defined in claim 2, wherein edges of said intake surface of said filter element are secured to a frame, and said frame is mounted in said housing.

4. The structure as defined in claim 3, wherein said plate spring is fixedly inserted at both ends thereof into an insertion groove formed at said frame.

5. The structure as defined in claim 1, wherein said amplitude limiting means includes plate springs that cross a center of said intake surface and exhaust surface of said filter element.

6. The structure as defined in claim 5, wherein edges of said intake surface of said filter element are secured to a frame, and said frame is mounted in said housing.

7. The structure as defined in claim 6, wherein said plate springs are fixedly inserted at both ends thereof into insertion grooves formed at said frame.

8. A canister air filter structure, comprising:
a housing;
a filter element configured to vibrate in response to air movement through the filter element, wherein the filter element is housed within the housing; and
a stopper for restricting an amplitude of vibration of said filter element.

9. The structure as defined in claim 8, wherein said stopper is a plate spring positioned substantially adjacent a surface of said filter element.
